(19) United States
(12) Patent Application Publication
(10) Pub. No.: US 2026/0303711 A1
(43) Pub. Date: Oct. 1, 2026

(54) METHOD AND SYSTEM FOR GENERATING A UNIQUE IDENTIFIER IN A DISTRIBUTED COMPUTING ENVIRONMENT

(71) Applicant: FAIR ISAAC CORPORATION, Minneapolis, MN (US)

(72) Inventors: Rajarshi Bhose, Bangalore (IN); Rollo du Pré, Coventry (GB); Yellen Seram, Imphal (IN); Anshul Sarpal, Round Rock, TX (US)

(21) Appl. No.: 19/091,017

(22) Filed: Mar. 26, 2025

(51) Int. Cl. H04L 69/28

(52) U.S. Cl. CPC H04L 69/28

(57) ABSTRACT

A method for generating a unique identifier (UID) in a distributed system, comprising: calling a UID generation service in response to detecting a qualified event, wherein the UID generation service is configured to generate a UID for indexing the qualified event, wherein the UID comprises a timestamp, a sequence value, and an ephemeral random identifier, wherein the timestamp records an occurrence time of the qualified event, the sequence value distinguishes multiple events generated within a same time unit; obtaining a current timestamp; comparing the current timestamp with last recorded timestamp; in response to that the current timestamp is earlier than the last recorded timestamp, retaining the last recorded timestamp and incrementing the sequence value; and assemble the last recorded timestamp and the incremented sequence value with the ephemeral random identifier to generate the UID for the qualified event.

### TECHNICAL FIELD

The subject matter described herein relates to distributed unique identifier generation systems, specifically systems and methods for generating time-ordered unique identifiers in a distributed computing environment without requiring pre-assigned node identifiers.

### BACKGROUND

Unique identifier (UID) generation is widely used in distributed computing environments for tasks such as event tracking, database indexing, transaction processing, and resource allocation. Many applications, including cloud computing, large-scale data processing, financial systems, and internet-of-things (IoT) networks, require UIDs that are globally unique, efficiently generated, and scalable across multiple computing nodes. Ensuring uniqueness while maintaining efficient allocation of UIDs in a distributed system presents several challenges, particularly in environments where multiple nodes operate independently without centralized coordination.

Traditional UID generation methods often rely on pre-assigned node identifiers to distinguish between instances generating UIDs. For example, some traditional UID generation schemes allocate a fixed number of bits to node IDs, requiring centralized coordination to ensure each node has an assigned node ID to distinguish itself from other nodes in the system, which is separate from the unique identifiers (UIDs) generated for tracking events. While this approach helps maintain uniqueness, it imposes scalability limitations since the number of available node identifiers is finite, requiring careful management as infrastructure scales. Moreover, centralized coordination mechanisms can introduce bottlenecks and single points of failure, reducing system reliability and increasing complexity in multi-region deployments.

Other approaches, such as Universally Unique Identifiers (UUIDs), eliminate the need for centralized coordination by leveraging random or pseudo-random values to ensure uniqueness. However, many UUID formats, such as UUID v4, are entirely random and lack inherent time-ordering, which can degrade performance in databases and distributed logs where sequential ordering is beneficial. While some variations, such as UUID v1 or UUID v7, incorporate timestamp information, they may still require MAC addresses or other assigned node identifiers, which can introduce security concerns or infrastructure dependencies. Additionally, the randomness in UUID-based approaches increases the likelihood of inefficiencies in storage and indexing systems.

Ensuring monotonic ordering of UIDs while allowing decentralized generation across multiple nodes presents another challenge. Systems that rely on synchronized clocks or central timestamp servers introduce additional infrastructure dependencies, making them less resilient to network failures or latency issues. Furthermore, UID generation mechanisms that assign static node identifiers can become a bottleneck when infrastructure scales dynamically, as pre-allocated identifiers must be carefully managed to prevent duplication and ensure high availability.

Existing solutions often require a tradeoff between scalability, uniqueness, ordering, and efficiency. Approaches relying on fixed node identifiers can limit flexibility, while fully decentralized methods may introduce performance inefficiencies or require additional mechanisms to ensure order preservation. As distributed computing environments continue to grow, there remains a need for a UID generation approach that can operate in a decentralized manner, support large-scale distributed deployments, maintain monotonic ordering, and eliminate the need for static node identifier assignments.

### SUMMARY

Methods, systems, and articles of manufacture, including computer program products, are provided for generating a unique identifier (UID) in a distributed system. In one aspect, there is provided a method for generating a unique identifier (UID) in a distributed system, comprising: calling a UID generation service in response to detecting a qualified event, wherein the UID generation service is configured to generate a UID for indexing the qualified event, wherein the UID comprises a timestamp, a sequence value, and an ephemeral random identifier, wherein the timestamp records an occurrence time of the qualified event, the sequence value distinguishes multiple events generated within a same time unit; and the ephemeral random identifier differentiates a node that is generating the qualified event against other nodes; obtaining a current timestamp; comparing the current timestamp with last recorded timestamp; in response to that the current timestamp is earlier than the last recorded timestamp, retaining the last recorded timestamp and incrementing the sequence value; and assemble the last recorded timestamp and the incremented sequence value with the ephemeral random identifier to generate the UID for the qualified event.

In some variations, when the sequence value reaches a predefined maximum within a given time unit, the method further comprises delaying UID generation until a next available time unit to maintain monotonic ordering.

In some variations, the method does not rely on a Network Time Protocol (NTP) for clock synchronization.

In some variations, wherein the UID generation service is deployed in a distributed computing environment comprising multiple geographically separated regions, each executing independent UID generation while maintaining global uniqueness through the ephemeral random identifier.

In some variations, the method further comprising adjusting the sequence value based on a predefined threshold to mitigate UID generation delays when processing high-frequency qualified events.

In some variations, the ephemeral random identifier is generated upon node startup and remains unchanged for an entirety of operational lifetime of the node before a restart.

In some variations, the ephemeral random identifier is stored in a temporary memory location and does not persist across node restarts.

In another aspect, there is provided a system comprising: a programmable processor; and a non-transient machine-readable medium storing instructions that, when executed by the processor, cause the at least one programmable processor to perform operations. The operations include calling a UID generation service in response to detecting a qualified event, wherein the UID generation service is configured to generate a UID for indexing the qualified event, wherein the UID comprises a timestamp, a sequence value, and an ephemeral random identifier, wherein the timestamp records an occurrence time of the qualified event, the sequence value distinguishes multiple events generated within a same time unit; and the ephemeral random identifier differentiates a node that is generating the qualified event against other nodes; obtaining a current timestamp; comparing the current timestamp with last recorded timestamp; in response to that the current timestamp is earlier than the last recorded timestamp, retaining the last recorded timestamp and incrementing the sequence value; and assemble the last recorded timestamp and the incremented sequence value with the ephemeral random identifier to generate the UID for the qualified event.

In some variations, when the sequence value reaches a predefined maximum within a given time unit, the operations further comprise delaying UID generation until a next available time unit to maintain monotonic ordering.

In some variations, the UID generation service is deployed in a distributed computing environment comprising multiple geographically separated regions, each executing independent UID generation while maintaining global uniqueness through the ephemeral random identifier.

In some variations, the operations further comprise adjusting the sequence value based on a predefined threshold to mitigate UID generation delays when processing high-frequency qualified events.

In some variations, the ephemeral random identifier is generated upon node startup and remains unchanged for an entirety of operational lifetime of the node before a restart.

In some variations, the ephemeral random identifier is stored in a temporary memory location and does not persist across node restarts.

In another aspect, there is provided a computer program product including a non-transitory computer readable medium storing instructions that, when executed by at least one programmable processor, cause the at least one programmable processor to perform operations. The operations include calling a UID generation service in response to detecting a qualified event, wherein the UID generation service is configured to generate a UID for indexing the qualified event, wherein the UID comprises a timestamp, a sequence value, and an ephemeral random identifier, wherein the timestamp records an occurrence time of the qualified event, the sequence value distinguishes multiple events generated within a same time unit; and the ephemeral random identifier differentiates a node that is generating the qualified event against other nodes; obtaining a current timestamp; comparing the current timestamp with last recorded timestamp; in response to that the current timestamp is earlier than the last recorded timestamp, retaining the last recorded timestamp and incrementing the sequence value; and assemble the last recorded timestamp and the incremented sequence value with the ephemeral random identifier to generate the UID for the qualified event.

In some variations, when the sequence value reaches a predefined maximum within a given time unit, the operations further comprise delaying UID generation until a next available time unit to maintain monotonic ordering.

In some variations, the computer program product does not rely on a Network Time Protocol (NTP) for clock synchronization.

In some variations, the UID generation service is deployed in a distributed computing environment comprising multiple geographically separated regions, each executing independent UID generation while maintaining global uniqueness through the ephemeral random identifier.

In some variations, the operations further comprise adjusting the sequence value based on a predefined threshold to mitigate UID generation delays when processing high-frequency qualified events.

In some variations, the ephemeral random identifier is generated upon node startup and remains unchanged for an entirety of operational lifetime of the node before a restart.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an exemplary architecture of a globally distributed unique ID generation system, in accordance with one or more embodiments of the current subject matter.

FIG. 2 is a diagram illustrating a flowchart of a process for generating a unique identifier (UID) in a distributed system, in accordance with one or more embodiments of the approach described herein.

FIG. 3 is a diagram illustrating a flowchart of a process for generating a unique identifier (UID) in a distributed system, in accordance with one or more embodiments of the approach described herein.

FIG. 4 depicts a block diagram illustrating a computing system consistent with implementations of the current subject matter.

When practical, like labels are used to refer to same or similar items in the drawings.

### DETAILED DESCRIPTION

The details of one or more variations of the subject matter described herein are set forth in the accompanying drawings.

As discussed above, there is a need for a solution that can generate unique identifiers in a distributed computing environment while supporting scalability, maintaining time ordering, and reducing dependencies on pre-assigned node identifiers. The approach described herein may address these considerations by generating UIDs based on a combination of a timestamp, a sequence value, and an ephemeral random identifier. The timestamp may record the occurrence time of a qualified event, allowing identifiers to be ordered based on when they were generated. The sequence value may distinguish multiple events occurring within the same time unit, enabling high-throughput UID generation without losing time-based ordering. The ephemeral random identifier, which may be assigned upon node startup, may differentiate a node generating the UID from other nodes, thereby reducing the likelihood of UID collisions across a distributed system.

In some embodiments, a UID generation service may be called in response to detecting a qualified event. A qualified event may refer to an operation or system action that requires an identifier for tracking, indexing, or transaction management. Upon receiving such a request, the UID generation service may obtain a current timestamp and compare it with a previously recorded timestamp. If the current timestamp is earlier than the last recorded timestamp, the approach described herein may retain the last recorded timestamp and increment the sequence value rather than allowing a regressed timestamp to be used directly. This may allow UID generation to remain time-ordered even if a node experiences a time shift.

In some embodiments, if the sequence value reaches a predefined maximum within a given time unit, UID generation may be delayed until the next available time unit. This may help ensure monotonic ordering and may prevent sequence overflows that could otherwise lead to duplicate UID values. Additionally, the approach described herein may support distributed deployments across multiple geographically separated regions, allowing UID generation to be executed independently in each region while maintaining global uniqueness through the ephemeral random identifier. Alternatively, in some embodiments, additional safeguards may be implemented to ensure UID uniqueness across regions without requiring inter-region coordination. For example, each region may append a region-specific identifier as part of the UID encoding scheme, ensuring that even if ephemeral random identifiers are coincidentally duplicated across regions, the resulting UIDs remain unique operates independently to generate UIDs without pre-allocating portions of the ephemeral random identifier, ensuring that node ID collisions remain statistically improbable. Alternatively, in some implementations, wherein each region operates on an offset time window to ensure that UIDs generated in separate regions do not overlap within the same time unit. Additionally, in some embodiments, a distributed entropy source may be leveraged to introduce additional randomness into ephemeral identifier generation, further reducing the probability of cross-region collisions and per-node collisions. In some embodiments, adjustments to the sequence value may be made based on a predefined threshold. For example, if UID generation is experiencing delays due to a high volume of qualified events, the system may modify the sequence increment strategy to optimize throughput. In some embodiments, the system may implement a predefined sequence value threshold that dynamically adjusts based on observed UID generation rates. For example, if the system detects a sustained high-frequency event load, it may dynamically adjust the sequence incrementing strategy while ensuring that UIDs remain ordered and non-overlapping. Alternatively, in some embodiments, the system may implement an adaptive threshold mechanism, wherein the sequence value limit is periodically recalibrated based on historical event processing rates. Additionally, the threshold adjustment may be linked to system performance metrics, such as CPU utilization or memory availability, to balance efficiency with resource constraints. Similarly, the ephemeral random identifier may be stored in a temporary memory location and may not persist across node restarts. In some embodiments, the ephemeral random identifier may be stored in volatile memory, such as RAM, to ensure that it is cleared upon node restart. This may prevent instances from retaining identifiers beyond their operational lifetime, further ensuring that each node restart results in a distinct ephemeral identifier. Alternatively, in some implementations, the ephemeral random identifier may be cached within an ephemeral storage location that is periodically refreshed based on a predefined expiration policy. Additionally, in some embodiments, security measures may be applied to prevent the ephemeral identifier from being stored in persistent logs, ensuring that it remains transient and unique to each operational session. This may allow each operational instance of the UID generation service to generate a new ephemeral random identifier upon startup, further supporting uniqueness across independent system restarts. The approach described herein may also mitigate time-related inconsistencies through an internal offset correction mechanism. If a clock moves significantly forward or backward, an adjustment may be applied to maintain consistent UID generation. In the case of clock regression, the system retains the last recorded timestamp and increments the sequence value instead of using a lower timestamp, ensuring that UIDs remain monotonic. In some embodiments, the approach described herein does not rely on an external time synchronization mechanism, such as the Network Time Protocol (NTP), to ensure consistency among distributed nodes. Instead, each node may operate using its local system clock, and any discrepancies between local timestamps may be addressed through timestamp comparison and sequence value incrementation. Alternatively, in some embodiments, a logical clock mechanism may be used to track event order without requiring strict global clock synchronization. Additionally, if clock drift is detected beyond a predefined threshold, corrective measures may be applied locally to maintain UID ordering while ensuring that the system remains independent of external time synchronization services. By integrating these techniques, the approach described herein may allow UID generation to remain scalable, time-ordered, and decentralized across distributed computing environments.

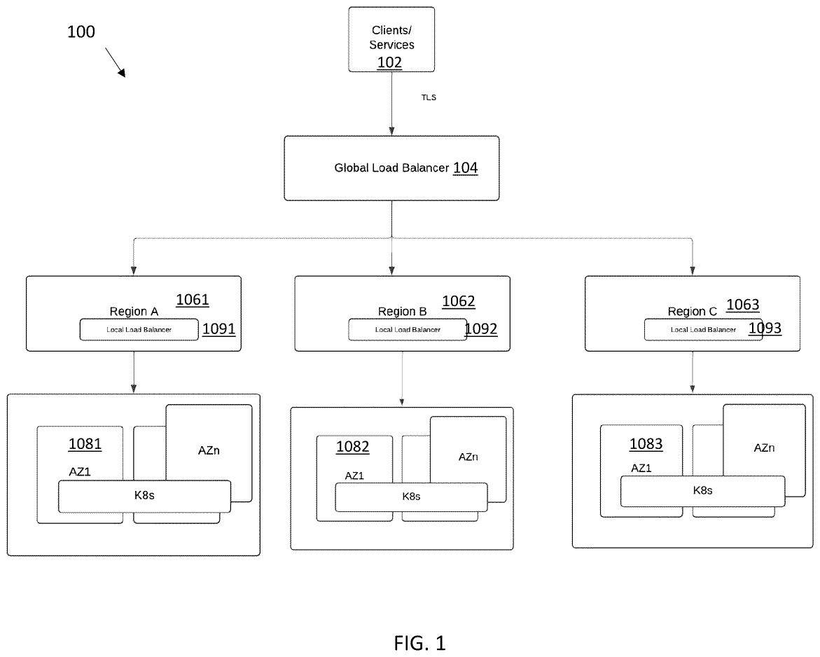

FIG. 1 is a diagram illustrating an exemplary architecture of a globally distributed unique ID generation system 100, in accordance with one or more embodiments of the current subject matter. As discussed herein, the globally distributed unique ID generation system 100 may facilitate high availability, scalability, and uniqueness of generated identifiers in a decentralized architecture. As shown in FIG. 1, the unique ID generation system 100 may include a global load balancer 104, regional load balancers 1061, 1062, and 1063, and Kubernetes-based compute clusters 1081, 1082, and 1083. These components may coordinate to generate unique identifiers while addressing challenges related to time drift, node coordination, and scalability limitations. A global load balancer 104 may receive requests from clients or services 102 and may route these requests to one of multiple geographically distributed regions, such as Region A 1061, Region B 1062, or Region C 1063. The global load balancer 104 may determine the optimal region for request handling by performing health checks on each region's local infrastructure. If a particular region is determined to be unavailable, the global load balancer 104 may direct traffic to an alternative region to maintain continuity of the ID generation process. Each region may include a regional (i.e., local) load balancer 1091, 1092, or 1093, which may act as an API gateway. In some embodiments, the regional load balancer 1091, 1092, or 1093 may terminate TLS connections from the global load balancer 104 and may perform rate limiting or DDoS protection. Additionally, the regional load balancer 1061, 1062, or 1063 may monitor the availability of Kubernetes-based services by conducting health checks. The approach described herein may utilize Kubernetes-based ID generation nodes 1081, 1082, and 1083 within each region. In some embodiments, a region may include multiple availability zones, such as AZ1 and AZn, each of which may host one or more Kubernetes nodes. Each node may run an ID generation algorithm, which may be executed within one or more pods. In some embodiments, a pod may refer to an execution unit within Kubernetes that encapsulates one or more containers and shares a network namespace. The ID generation process may generate unique identifiers based at least in part on a timestamp and an ephemeral node identifier. Each pod may generate a n-bit ephemeral random prefix upon startup, ensuring that no static identifiers are assigned, wherein n is an integral that is greater than 59, which may be generated at pod startup and may be refreshed if the pod restarts. In some embodiments, each node or pod may be autoscaled based on system load. In some embodiments, the approach described herein may generate unique identifiers without requiring pre-assigned node identifiers. For example, rather than relying on a fixed node ID assigned at deployment, each pod may generate a 60-bit ephemeral random number upon initialization. This may allow scalability by reducing the need for centralized coordination of node identifiers. The approach described herein may generate identifiers in a time-ordered manner. For example, each generated ID may include a timestamp, which may enable sorting of identifiers based on their creation time. In some embodiments, a monotonic timestamp adjustment may be implemented to mitigate potential disruptions caused by time drift, thereby ensuring that identifiers remain ordered, even when system clocks exhibit variations. In some embodiments, the system may be deployed across multiple regions with traffic distributed by load balancers 104, 1061, 1062, and 1063. The use of Kubernetes-based deployment 1081, 1082, and 1083 may allow autoscaling of resources, thereby adjusting computational capacity based on demand. This may allow the system to allocate additional pods or nodes as needed without manual intervention. The approach described herein may be utilized in both single-tenant and multi-tenant environments. For example, in a single-tenant deployment, a single cluster 1081, 1082, or 1083 may span multiple availability zones, whereas in a multi-tenant scenario, multiple independent clusters may be deployed across different regions. By distributing identifier generation across multiple locations, the system may mitigate single points of failure and may allow efficient request handling across geographically dispersed clients

As described herein elsewhere, there is a need to eliminate the usage of an assigned node ID in the UID generation process to allow scalability. In some embodiments, a UID generation system may be deployed in a distributed computing environment where multiple nodes operate independently. Traditionally, UID generation mechanisms rely on pre-assigned node identifiers to distinguish different instances generating UIDs. While this approach may work for environments with a fixed number of nodes, it may impose constraints when the system needs to scale dynamically. The total number of node IDs is often limited by the bit allocation assigned for node identification, and as infrastructure grows, maintaining a registry of assigned node IDs may introduce operational complexity.

In some embodiments, a centralized node ID assignment mechanism may require coordination among nodes to prevent conflicts, which may introduce a bottleneck in large-scale distributed systems. Additionally, pre-assigned node IDs may lead to challenges in multi-region deployments, where each region may need an independent set of node identifiers, further increasing management overhead. The approach described herein removes the need for assigned node IDs by introducing an ephemeral random identifier, which in some embodiments, may be generated upon node startup and remain unchanged for an entirety of the operational lifetime of the node before a restart. This ephemeral random identifier may differentiate a node generating a UID from other nodes without requiring pre-assigned values.

The removal of assigned node IDs may introduce technical challenges, particularly in ensuring uniqueness across distributed nodes. Without an assigned identifier, nodes must independently generate an ephemeral random identifier for themselves without coordination. In some embodiments, this may be accomplished by generating a 60-bit random number at node startup. However, because this identifier is generated randomly, there exists a probability, however low, that two nodes may independently generate the same ephemeral random identifier. If two nodes with the same ephemeral identifier also generate UIDs with identical timestamps and sequence values, a collision may occur. To address this, the approach described herein may leverage the large bit space of the ephemeral random identifier to reduce the probability of collision to a practically negligible level. Additionally, in some embodiments, if a node restarts, a new ephemeral identifier may be assigned, ensuring that different operational instances of the UID generation service remain distinguishable.

The removal of assigned node IDs also impacts how uniqueness is maintained in a distributed system. In some embodiments, UID generation may rely on a timestamp to record an occurrence time of a qualified event, ensuring that UIDs remain ordered based on when they were created. However, without an assigned node identifier, there may be cases where different nodes generate UIDs with the same timestamp and sequence value, particularly in high-throughput environments. The approach described herein may mitigate this by ensuring that each node independently increments a sequence value when generating multiple UIDs within a same time unit. If the sequence value reaches a predefined maximum, UID generation may be delayed until a next available time unit to maintain monotonic ordering

Time drift may further complicate UID generation when assigned node IDs are removed. In some embodiments, nodes operate with local system clocks, which may not always be perfectly synchronized. A node experiencing clock drift may generate a UID with a timestamp that is earlier than its last recorded timestamp, leading to potential ordering issues. To address this, the approach described herein may compare a current timestamp with a last recorded timestamp before generating a new UID. If the current timestamp is earlier than the last recorded timestamp, the system may retain the last recorded timestamp and increment the sequence value rather than using the regressed timestamp. This may allow UIDs to remain time-ordered even when clock drift occurs.

In some embodiments, the UID generation service operates on the basis of its local system clock, thereby eliminating any reliance on external time synchronization mechanisms such as the Network Time Protocol (NTP) to maintain a monotonically increasing order of generated unique identifiers. Additionally, if a clock moves significantly forward, an internal offset correction may be applied to prevent sudden jumps in UID values. In some embodiments, the approach described herein may deploy UID generation services across multiple geographically separated regions, each executing independent UID generation while maintaining global uniqueness through the ephemeral random identifier. In some implementations, this may allow for distributed scalability while ensuring that UIDs remain unique across different regions without requiring centralized coordination.

The approach described herein may further support high-frequency event processing by adjusting the sequence value based on a predefined threshold. In some embodiments, if a large number of qualified events are detected within a short time frame, the sequence value may be modified to optimize throughput while maintaining uniqueness. Additionally, the ephemeral random identifier may be stored in a temporary memory location and may not persist across node restarts. This may ensure that each operational instance of the UID generation service generates a new ephemeral identifier, further supporting uniqueness in distributed environments. By integrating these techniques, the approach described herein may allow UID generation to operate in a decentralized manner, maintaining uniqueness and time ordering without requiring pre-assigned node identifiers.

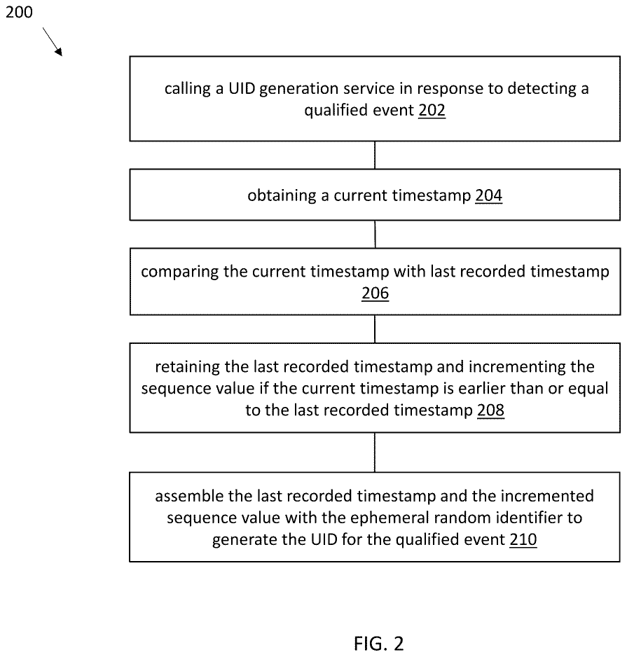

FIG. 2 is a diagram illustrating a flowchart of a process 200 for generating a unique identifier (UID) in a distributed system, in accordance with one or more embodiments of the approach described herein.

As shown in FIG. 2, the process 200 may begin with operation 202, wherein a UID generation service may be called in response to detecting a qualified event. In some embodiments, a qualified event may refer to an occurrence in a system that necessitates the generation of a unique identifier for indexing, tracking, or referencing purposes. For example, a qualified event may include, but is not limited to, the creation of a new database entry, the initiation of a transaction, the logging of an event in a distributed system, or any other operation that requires a globally unique identifier to distinguish the event from others. Alternatively, in some embodiments, a qualified event may correspond to a system state transition, such as a change in configuration, an update to a distributed ledger, or a checkpoint creation in a long-running process. Additionally, the system may preemptively generate UIDs in response to anticipated future events, allowing identifiers to be allocated before they are needed.

The process may then proceed to operation 204, wherein the system obtains a current timestamp. In some embodiments, the timestamp may represent the system time at which the UID generation request is processed, expressed in milliseconds or another unit of time resolution. The use of timestamps may allow for chronological ordering of UIDs in a distributed system. Alternatively, in some embodiments, the system may obtain a timestamp that is adjusted using a predefined offset correction mechanism, ensuring consistency across multiple nodes that may have slight variations in their system clocks. Additionally, in some implementations, the system may retrieve a hybrid timestamp that includes both logical and physical time components, allowing for logical time progression even in the presence of clock synchronization delays.

At operation 206, the system may compare the obtained current timestamp with a last recorded timestamp. In some embodiments, the last recorded timestamp may represent the most recent timestamp used for UID generation before the current request. This comparison may determine whether the current timestamp is greater than, equal to, or earlier than the last recorded timestamp. Alternatively, in some embodiments, the system may maintain a history of previously used timestamps within a predefined time window and compare the current timestamp against multiple prior timestamps to detect inconsistencies in time progression. Additionally, in some embodiments, the system may apply a threshold-based validation, wherein timestamps that deviate beyond a predefined tolerance range from the last recorded timestamp may trigger additional corrective actions before UID generation proceeds.

If the system detects that the current timestamp is earlier than the last recorded timestamp, the process may proceed to operation 208, wherein the system retains the last recorded timestamp and increments a sequence value. In some embodiments, the sequence value may be used to distinguish multiple events generated within a same time unit, allowing multiple UIDs to be issued without ambiguity. The retention of the last recorded timestamp and the incrementation of the sequence value may ensure that UID generation remains monotonic, preventing identifiers from being issued with an out-of-order timestamp due to time drift or clock synchronization inconsistencies. Alternatively, in some embodiments, the system may adjust the sequence value increment dynamically based on the frequency of UID generation requests, allowing for optimized allocation of sequence numbers when handling high-throughput workloads. Additionally, in some embodiments, instead of retaining the last recorded timestamp, the system may use a predefined fallback strategy, such as adjusting the timestamp forward to the nearest available time slot, while still ensuring ordered UID generation.

The process may then advance to operation 210, wherein the system assembles the last recorded timestamp, the incremented sequence value, and an ephemeral random identifier to generate the UID for the qualified event. In some embodiments, the ephemeral random identifier may be generated upon node startup and may remain unchanged for the entirety of the node's operational lifetime before a restart. The ephemeral random identifier may differentiate a node generating the qualified event against other nodes without requiring an assigned node identifier. Alternatively, in some embodiments, the ephemeral random identifier may be periodically regenerated based on predefined time intervals or system state changes, allowing nodes to refresh their identifiers under controlled conditions. Additionally, in some embodiments, the ephemeral random identifier may be derived from a combination of hardware-based entropy sources and cryptographic random number generation techniques to enhance uniqueness while avoiding reliance on an assigned node ID configurations.

The combination of the timestamp, sequence value, and ephemeral random identifier may allow UIDs to be generated in a time-ordered and distributed manner while reducing the risk of collision across independent nodes in a distributed system. Alternatively, in some embodiments, the UID generation process may incorporate additional metadata fields, such as region identifiers or workload-specific prefixes, to further customize UID allocation based on deployment-specific requirements. Additionally, the generated UID may be formatted according to a predefined encoding scheme, such as a structured binary representation or a human-readable alphanumeric format, depending on system requirements.

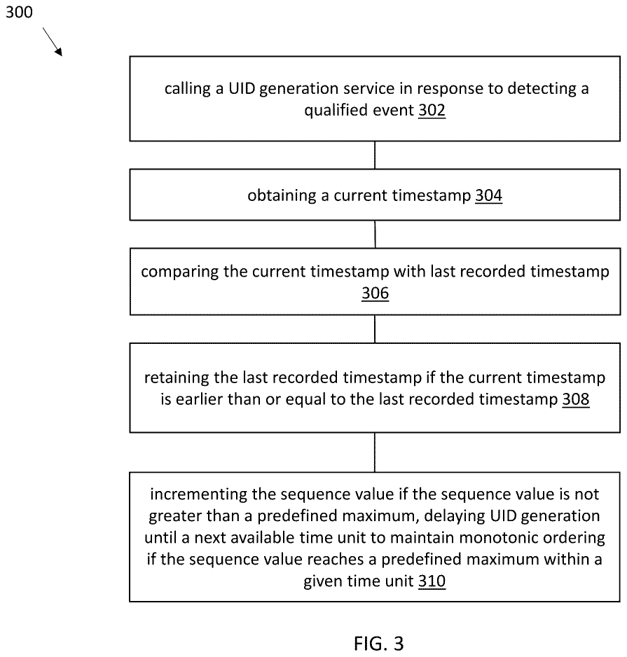

FIG. 3 is a diagram illustrating a flowchart of a process 300 for generating a unique identifier (UID) in a distributed system, in accordance with one or more embodiments of the approach described herein. As shown in FIG. 3, the process 300 may begin with operation 302, wherein a UID generation service may be called in response to detecting a qualified event. In some embodiments, a qualified event may refer to an occurrence that necessitates the generation of a unique identifier, such as the creation of a new record in a database, the initiation of a transaction, or logging an event in a distributed system. The process then proceeds to operation 304, where the system obtains a current timestamp representing the system time at which the UID request is processed. Next, in operation 306, the system compares the current timestamp with the last recorded timestamp to determine whether time progression is maintained or if adjustments are needed to ensure monotonic UID ordering.

At operation 308, if the system detects that the current timestamp is earlier than the last recorded timestamp, the last recorded timestamp is retained rather than using the regressed timestamp. Alternatively, in some embodiments, if the system detects that the current timestamp has moved significantly forward beyond a predefined threshold, an internal offset correction mechanism may be applied. In some embodiments, the system may gradually adjust the timestamp by incrementing the last recorded timestamp in controlled steps rather than adopting the new timestamp immediately. This may prevent sudden jumps in UID values while maintaining monotonic ordering. Alternatively, the system may apply a weighted correction factor, wherein the adjusted timestamp is derived as a function of both the last recorded timestamp and the new timestamp, ensuring smooth progression. Additionally, in some implementations, the system may introduce an artificial delay before UID generation resumes, allowing the adjusted timestamp to stabilize before generating new UIDs. This may prevent inconsistencies caused by clock drift or system time adjustments. In some embodiments, retaining the last recorded timestamp may be combined with other corrective actions, such as incrementing a sequence value, to ensure that UID values continue to increase monotonically. Alternatively, the system may apply additional logic to determine whether the time discrepancy exceeds a predefined threshold and, if so, take further corrective measures.

The process then advances to operation 310, which addresses scenarios where the sequence value reaches its predefined maximum within a given time unit. In some embodiments, the sequence value may distinguish multiple UIDs generated within the same timestamp and may be incremented as new UIDs are issued. If the sequence value has not yet reached its maximum, UID generation may proceed by incrementing the sequence value. However, if the sequence value has reached a predefined limit, the system may delay UID generation until the next available time unit. This delay ensures that UIDs remain time-ordered and prevents sequence overflows that could lead to duplicate identifiers within a given timestamp. Alternatively, in some embodiments, the predefined sequence limit may be dynamically adjusted based on system load while ensuring that UID ordering remains intact by controlling the rate of sequence value incrementation.

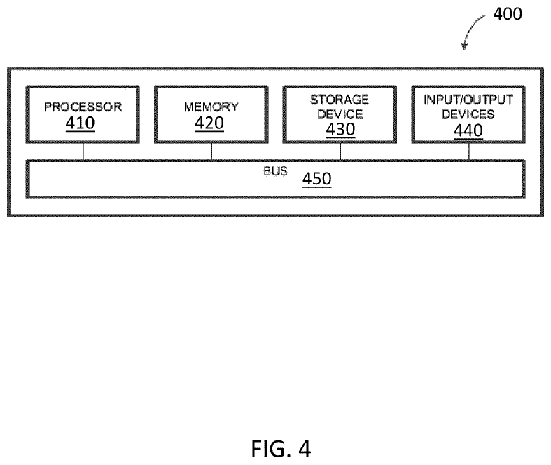

FIG. 4 depicts a block diagram illustrating a computing system 400 consistent with implementations of the current subject matter. As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The computing system 400 may additionally or alternatively include a graphic processing unit (GPU), such as for image processing, and/or an associated memory for the GPU. The GPU and/or the associated memory for the GPU may be interconnected via the system bus 450 with the processor 410, the memory 420, the storage device 430, and the input/output devices 440. The memory associated with the GPU may store one or more images described herein, and the GPU may process one or more of the images described herein. The GPU may be coupled to and/or form a part of the processor 410. The processor 410 is capable of processing instructions for execution within the computing system 400. Such executed instructions can implement one or more components. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for generating a unique identifier (UID) in a distributed system, comprising:
calling a UID generation service in response to detecting a qualified event, wherein the UID generation service is configured to generate a UID for indexing the qualified event, wherein the UID comprises a timestamp, a sequence value, and an ephemeral random identifier, wherein the timestamp records an occurrence time of the qualified event, the sequence value distinguishes multiple events generated within a same time unit; and the ephemeral random identifier differentiates a node that is generating the qualified event against other nodes;
obtaining a current timestamp;
comparing the current timestamp with last recorded timestamp;
in response to that the current timestamp is earlier than the last recorded timestamp, retaining the last recorded timestamp and incrementing the sequence value; and
assemble the last recorded timestamp and the incremented sequence value with the ephemeral random identifier to generate the UID for the qualified event.

2. The method of claim 1, wherein when the sequence value reaches a predefined maximum within a given time unit, the method further comprises delaying UID generation until a next available time unit to maintain monotonic ordering.

3. The method of claim 1, wherein the method does not rely on a Network Time Protocol (NTP) for clock synchronization.

4. The method of claim 1, wherein the UID generation service is deployed in a distributed computing environment comprising multiple geographically separated regions, each executing independent UID generation while maintaining global uniqueness through the ephemeral random identifier.

5. The method of claim 1, further comprising adjusting the sequence value based on a predefined threshold to mitigate UID generation delays when processing high-frequency qualified events.

6. The method of claim 1, wherein the ephemeral random identifier is generated upon node startup and remains unchanged for an entirety of operational lifetime of the node before a restart.

7. The method of claim 6, wherein the ephemeral random identifier is stored in a temporary memory location and does not persist across node restarts.

8. A system for generating a unique identifier (UID) in a distributed system comprising:
at least one programmable processor; and
a non-transient machine-readable medium storing instructions that, when executed by the processor, cause the at least one programmable processor to perform operations comprising:
calling a UID generation service in response to detecting a qualified event, wherein the UID generation service is configured to generate a UID for indexing the qualified event, wherein the UID comprises a timestamp, a sequence value, and an ephemeral random identifier, wherein the timestamp records an occurrence time of the qualified event, the sequence value distinguishes multiple events generated within a same time unit; and the ephemeral random identifier differentiates a node that is generating the qualified event against other nodes;
obtaining a current timestamp;
comparing the current timestamp with last recorded timestamp;
in response to that the current timestamp is earlier than the last recorded timestamp, retaining the last recorded timestamp and incrementing the sequence value; and
assemble the last recorded timestamp and the incremented sequence value with the ephemeral random identifier to generate the UID for the qualified event.

9. The system of claim 8, wherein when the sequence value reaches a predefined maximum within a given time unit, the operations further comprise delaying UID generation until a next available time unit to maintain monotonic ordering.

10. The system of claim 8, wherein the system does not rely on a Network Time Protocol (NTP) for clock synchronization.

11. The system of claim 8, wherein the UID generation service is deployed in a distributed computing environment comprising multiple geographically separated regions, each executing independent UID generation while maintaining global uniqueness through the ephemeral random identifier.

12. The system of claim 8, wherein the operations further comprise adjusting the sequence value based on a predefined threshold to mitigate UID generation delays when processing high-frequency qualified events.

13. The system of claim 8, wherein the ephemeral random identifier is generated upon node startup and remains unchanged for an entirety of operational lifetime of the node before a restart.

14. The system of claim 13, wherein the ephemeral random identifier is stored in a temporary memory location and does not persist across node restarts.

15. A computer program product for generating a unique identifier (UID) in a distributed system comprising a non-transient machine-readable medium storing instructions that, when executed by at least one programmable processor, cause the at least one programmable processor to perform operations comprising:
calling a UID generation service in response to detecting a qualified event, wherein the UID generation service is configured to generate a UID for indexing the qualified event, wherein the UID comprises a timestamp, a sequence value, and an ephemeral random identifier, wherein the timestamp records an occurrence time of the qualified event, the sequence value distinguishes multiple events generated within a same time unit; and the ephemeral random identifier differentiates a node that is generating the qualified event against other nodes;
obtaining a current timestamp;
comparing the current timestamp with last recorded timestamp;
in response to that the current timestamp is earlier than the last recorded timestamp, retaining the last recorded timestamp and incrementing the sequence value; and
assemble the last recorded timestamp and the incremented sequence value with the ephemeral random identifier to generate the UID for the qualified event.

16. The computer program product of claim 15, wherein when the sequence value reaches a predefined maximum within a given time unit, the operations further comprise delaying UID generation until a next available time unit to maintain monotonic ordering.

17. The computer program product of claim 15, wherein the computer program product does not rely on a Network Time Protocol (NTP) for clock synchronization.

18. The computer program product of claim 15, wherein the UID generation service is deployed in a distributed computing environment comprising multiple geographically separated regions, each executing independent UID generation while maintaining global uniqueness through the ephemeral random identifier.

19. The computer program product of claim 15, wherein the operations further comprise adjusting the sequence value based on a predefined threshold to mitigate UID generation delays when processing high-frequency qualified events.

20. The computer program product of claim 15, wherein the ephemeral random identifier is generated upon node startup and remains unchanged for an entirety of operational lifetime of the node before a restart.
